(19) United States
(12) Patent Application Publication
(10) Pub. No.: US 2025/0227253 A1
(43) Pub. Date: Jul. 10, 2025

(54) SAMPLE POSITION AND BLOCK CHARACTERISTIC DEPENDENT INTRA-PREDICTION FOR VIDEO CODING

(71) Applicant: QUALCOMM Incorporated, San Diego, CA (US)

(72) Inventors: Bappaditya Ray, San Diego, CA (US); Hongtao Wang, San Diego, CA (US); Vadim Seregin, San Diego, CA (US); Marta Karczewicz, San Diego, CA (US); Patrick Garus, München (DE); Samuel James Eadie, München (DE); Gleb Verba, Munich (DE)

(21) Appl. No.: 19/013,288

(22) Filed: Jan. 8, 2025

Related U.S. Application Data
(60) Provisional application No. 63/619,651, filed on Jan. 10, 2024.
(60) Provisional application No. 63/570,608, filed on Mar. 27, 2024.

(51) Int. Cl. H04N 19/167; H04N 19/117; H04N 19/176

(52) U.S. Cl. CPC H04N 19/167; H04N 19/117; H04N 19/176

(57) ABSTRACT

An example device for decoding video data includes: a memory for storing video data; and a processing system implemented in circuitry and configured to: generating a prediction block for a current block of the video data using a sample position-dependent intra-prediction mode, including, for one or more samples of the prediction block: select a filter for the sample according to a shape of the current block and a position of the sample; and predict the sample using the selected filter; decode a residual block for the current block of the video data; and combine the prediction block with the residual block to decode the current block of the video data.

This application claims the benefit of U.S. Provisional Application No. 63/619,651, filed Jan. 10, 2024, and of U.S. Provisional Application No. 63/570,608 filed Mar. 27, 2024, the entire contents of each of which are hereby incorporated by reference.

### TECHNICAL FIELD

This disclosure relates to video coding, including video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for performing intra-prediction that is sample position and block characteristic dependent. For example, a causal template may include reference samples to be used to generate a prediction block for a current block. The causal template may include one or more rows of samples above the current block, each row having a width of, e.g., twice the width of the current block. The causal template may additionally or alternatively include one or more columns of samples to the left of the current block, each column having a height of, e.g., twice the height of the current block. To generate the prediction block, a video coder may multiply a matrix by the causal template. For example, the video coder may select the matrix (e.g., a filter) on a sample-by-sample basis and multiply the matrix by the causal template to calculate a predicted sample value for the sample. The matrix may be selected according to an intra-prediction direction, a size of the current block, a shape of the current block, a position of the sample, and/or other characteristics of the current block.

In one example, a method of decoding video data includes: generating a prediction block for a current block of the video data using a sample position-dependent intra-prediction mode, including, for one or more samples of the prediction block: selecting a filter for the sample according to a shape of the current block and a position of the sample; and predicting the sample using the selected filter; decoding a residual block for the current block of the video data; and combining the prediction block with the residual block to decode the current block of the video data.

In another example, a device for decoding video data includes: a memory for storing video data; and a processing system implemented in circuitry and configured to: generating a prediction block for a current block of the video data using a sample position-dependent intra-prediction mode, including, for one or more samples of the prediction block: select a filter for the sample according to a shape of the current block and a position of the sample; and predict the sample using the selected filter; decode a residual block for the current block of the video data; and combine the prediction block with the residual block to decode the current block of the video data.

In another example, a method of encoding video data includes: generating a prediction block for a current block of the video data using a sample position-dependent intra-prediction mode, including, for one or more samples of the prediction block: selecting a filter for the sample according to a shape of the current block and a position of the sample; and predicting the sample using the selected filter; forming a residual block for the current block of the video data as a sample-by-sample difference between the current block and the prediction block; and encoding the residual block and prediction information representative of the sample position-dependent intra-prediction mode for the current block.

In another example, a device for encoding video data includes: a memory for storing video data; and a processing system implemented in circuitry and configured to: generate a prediction block for a current block of the video data using a sample position-dependent intra-prediction mode, including, for one or more samples of the prediction block: select a filter for the sample according to a shape of the current block and a position of the sample; and predict the sample using the selected filter; form a residual block for the current block of the video data as a sample-by-sample difference between the current block and the prediction block; and encode the residual block and prediction information representative of the sample position-dependent intra-prediction mode for the current block.

The details of one or more examples are set forth in the accompanying drawings and the description below. Other features, objects, and advantages will be apparent from the description, drawings, and claims.

### BRIEF DESCRIPTION OF THE DRAWINGS

FIG. 1 is a block diagram illustrating an example video encoding and decoding system that may perform the techniques of this disclosure.

FIG. 2 is a conceptual diagram illustrating an example set of directions of intra-prediction modes.

FIG. 3 is a conceptual diagram illustrating an example matrix intra prediction (MIP) process.

FIG. 4 is a block diagram illustrating an example causal template for a current block of video data according to techniques of this disclosure.

FIG. 5 is a block diagram illustrating an example video encoder that may perform the techniques of this disclosure.

FIG. 6 is a block diagram illustrating an example video decoder that may perform the techniques of this disclosure.

FIG. 7 is a flowchart illustrating an example method for encoding a current block in accordance with the techniques of this disclosure.

FIG. 8 is a flowchart illustrating an example method for decoding a current block in accordance with the techniques of this disclosure.

FIG. 9 is a flowchart illustrating an example method of predicting a block of video data according to techniques of this disclosure.

### DETAILED DESCRIPTION

Video coding standards include ITU-T H.261, ISO/IEC MPEG-1 Visual, ITU-T H.262 or ISO/IEC MPEG-2 Visual, ITU-T H.263, ISO/IEC MPEG-4 Visual (MPEG-4 Part 2), ITU-T H.264 (also known as ISO/IEC MPEG-4 AVC), including its Scalable Video Coding (SVC) and Multiview Video Coding (MVC) extensions, ITU-T H.265 (also known as ISO/IEC MPEG-4 HEVC) with its extensions, and ITU-T H.266/Versatile Video Coding (VVC). Research is ongoing to further improve coding performance, including development of an enhanced compression model (ECM).

Video coding generally includes partitioning frames of video data into blocks, then coding each block. Coding a block generally includes forming a prediction block for a current block, and coding a residual representing differences between the prediction block and the original data for the current block. Prediction may be intra-frame (in which case the prediction block is generated from data of the current frame) or inter-frame (in which case the prediction block is generated from data of a previously coded frame).

According to the techniques of this disclosure, intra-prediction may be performed based on characteristics of a current block and/or, for each sample, a position of the sample. In this manner, a prediction block may more accurately reflect the original block, thereby reducing residual data for the current block and, thus, reducing a bitrate of an encoded bitstream.

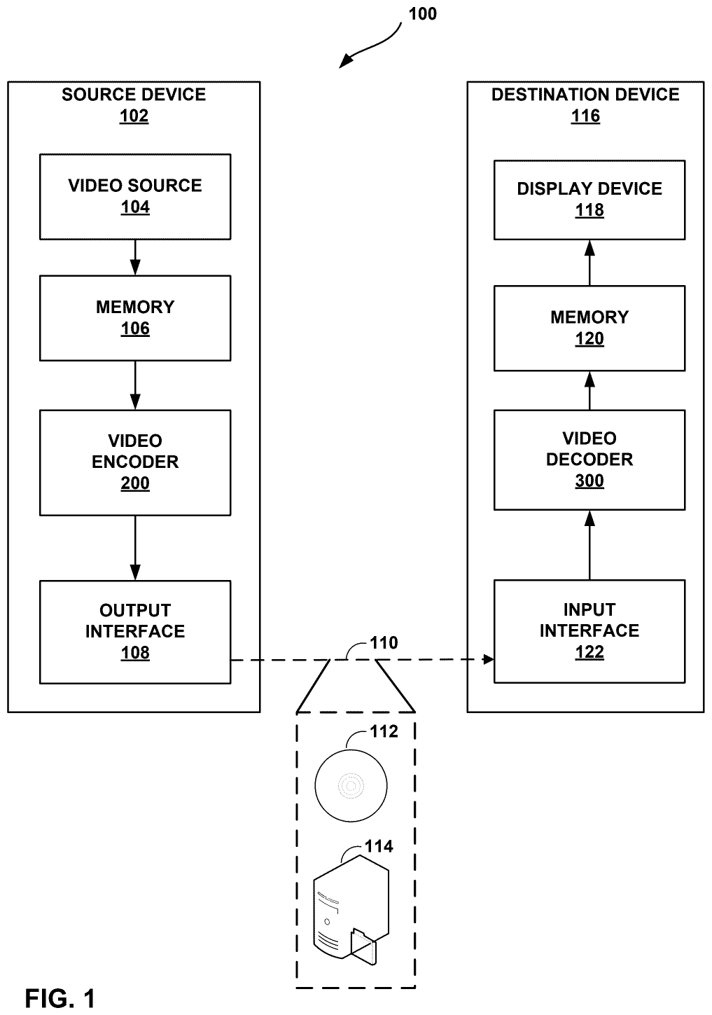

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for performing sample position and block characteristic-dependent intra-prediction. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for sample position and block characteristic-dependent intra-prediction. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any other video coding techniques.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component may be an array or single sample from one of the three arrays (luma and two chroma) for a picture in 4:2:0, 4:2:2, or 4:4:4 color format, or an array or a single sample of the array for a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

Per techniques of this disclosure, video encoder 200 and video decoder 300 may perform a sample position-dependent intra-prediction mode. That is, for one or more samples (e.g., all samples or a subset of the samples) of the current block to be predicted, video encoder 200 and video decoder 300 may select a filter for the sample according to, e.g., a shape of the current block and a position of the sample, then predict the sample using the selected filter. When fewer than all samples are predicted using a corresponding filter, video encoder 200 and video decoder 300 may interpolate the predicted samples of an intermediate prediction block to form a final prediction block. The filter may be a matrix of coefficients that video encoder 200 and video decoder 300 apply to a causal template neighboring the current block. For example, the causal template may be a number of samples to the left of and/or above the current block. In some examples, video encoder 200 and video decoder 300 may determine a number of lines of reference pixels neighboring the current block to include in the causal template according to a size of the current block. The causal template may have a height that is equal to or greater than (e.g., twice as large as) the height of the current block and/or a width that is equal to or greater than (e.g., twice as large as) the width of the current block.

Video encoder 200 and video decoder 300 may enable or disable the sample position-dependent intra-prediction mode according to one or more various criteria, alone or in combination. For example, video encoder 200 may only use the sample position-dependent intra prediction mode when a size of the current block is less than a threshold. The size may correspond to an area of the current block or a dimension, such as a width and/or a height of the current block.

Additionally or alternatively, video encoder 200 and video decoder 300 may determine to use the sample position-dependent intra-prediction mode based on an aspect ratio for the current block. The aspect ratio may correspond to a ratio of the width of the current block to the height of the current block. In some examples, video encoder 200 and video decoder 300 may disable the sample position-dependent intra-prediction mode when the current block is relatively narrow, e.g., where the width of the current block is significantly different than the height of the current block.

Additionally or alternatively, video encoder 200 and video decoder 300 may determine to use the sample position-dependent intra-prediction mode only for certain determined intra-prediction angular modes, based on a size of the current block. For example, for blocks having a width less than 32 samples and a height less than 32 samples, video encoder 200 and video decoder 300 may determine to use the sample position-dependent intra-prediction mode for angular modes having index values of 0, 1, or (2+2*k) where k is an integer value between 0 and 32, inclusive. As another example, for blocks having dimensions greater than or equal to 32 (e.g., a width greater than or equal to 32 or a height greater than or equal to 32), video encoder 200 and video decoder 300 may determine to use the sample position-dependent intra-prediction mode for angular modes having index values of 0, 1, or (2+4*k) where k is an integer value between 0 and 16, inclusive.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

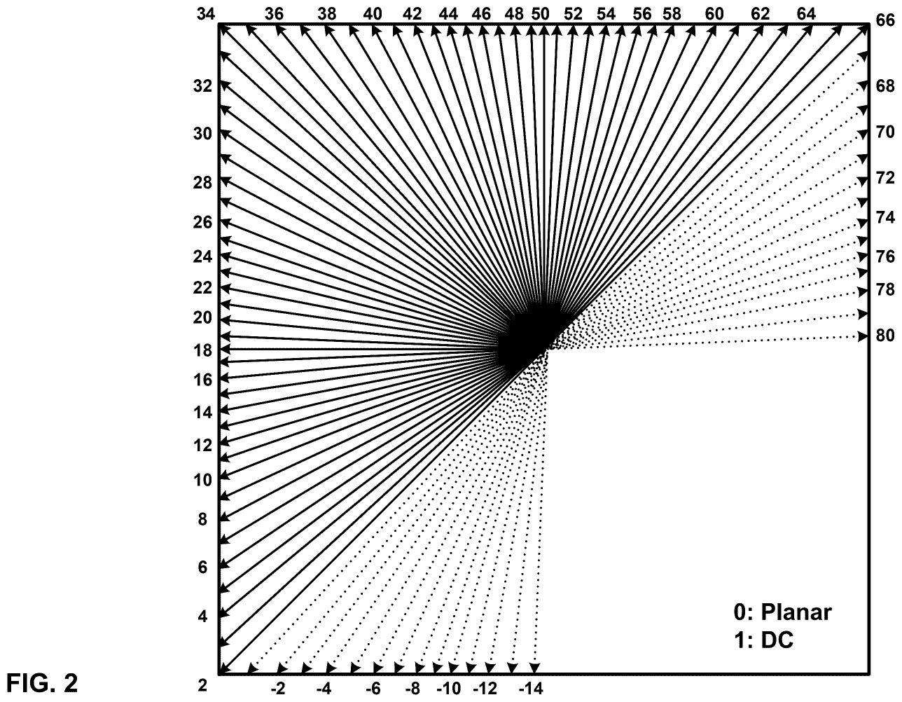

FIG. 2 is a conceptual diagram illustrating an example set of directions of intra-prediction modes. In ITU-T H.266/VVC, 65 different directional intra-prediction modes are used, as shown in FIG. 2. The intra-prediction modes further include planar and DC modes, which may be considered non-directional. The directional intra-prediction modes shown in FIG. 2 may apply to all block sizes and for both luma and chroma intra predictions.

In VVC and ECM, position-dependent prediction combination (PDPC) is an intra prediction technique applied to luma and chroma components. According to PDPC, a video coder (such as video encoder 200 or video decoder 300 of FIG. 1) may combine an original intra prediction signal with unfiltered or filtered boundary reference samples to generate a final prediction signal. According to VVC and ECM, the video coder may apply PDPC to the following intra modes without signalling: planar, DC, horizontal, vertical, and the angular modes with positive angle (modes having mode number less than 18 and greater than 50). In ECM, a gradient scheme of doing PDPC is extended from horizontal/vertical modes to some of the angular modes.

This disclosure recognizes that, although in VVC and ECM, PDPC includes position-dependent prediction of samples, PDPC is not applied to all available directional modes. For example, from mode 19 to mode 49 (modes having prediction from top-left), per VVC and ECM, PDPC is not applied. Moreover, conventional PDPC according to VVC and ECM only uses 1 reference line to perform the prediction.

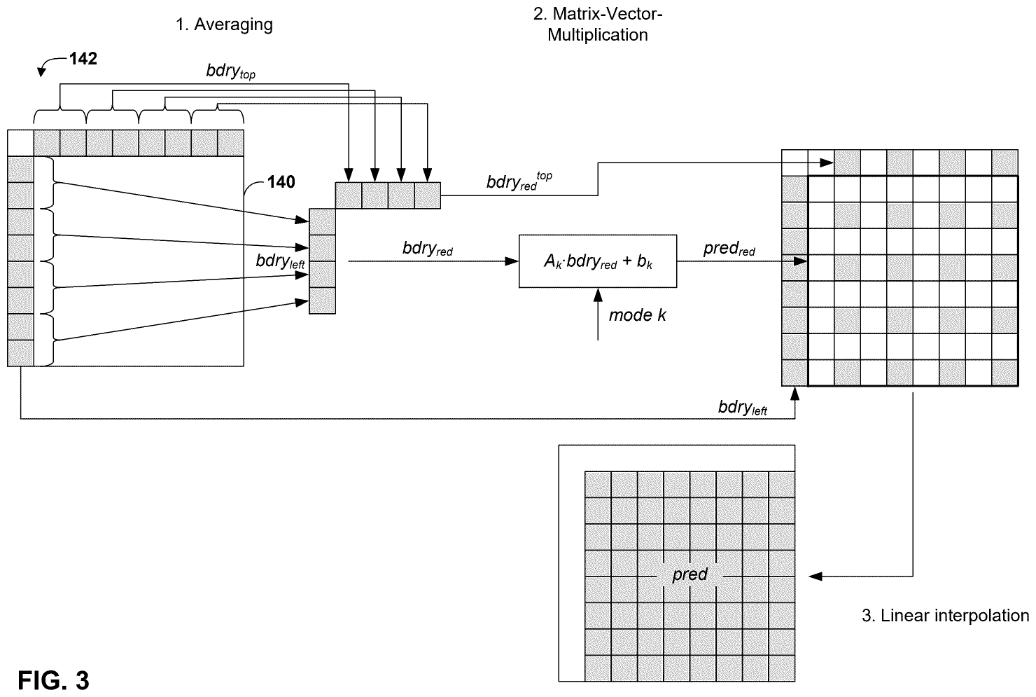

FIG. 3 is a conceptual diagram illustrating an example matrix intra prediction (MIP) process. According to MIP, to predict the samples of a rectangular block 140 of width W and height H, video encoder 200 or video decoder 300 may use neighboring reference samples 142 including one line of H reconstructed neighboring boundary samples left of the block and one line of W reconstructed neighboring boundary samples above the block as input. If the reconstructed samples are unavailable, video encoder 200 or video decoder 300 may generate the reconstructed samples as is done in conventional intra prediction. The generation of the prediction signal may be based on the following three steps, which are averaging, matrix vector multiplication, and linear interpolation, as shown in FIG. 3.

Various different size values (e.g., three different size values) may be used for MIP. An index “idx” may be defined as follows. For idx in {0, 1, 2} there are 16, 12, and 6 matrices defined, which also defines the number of modes for that given idx. Additionally, each mode may be transposed, where the samples from left and above are swapped before performing matrix-vector multiplication. So, additionally, a transpose flag may be signaled (along with the mode signaling) when a coding unit (CU) is coded using MIP.

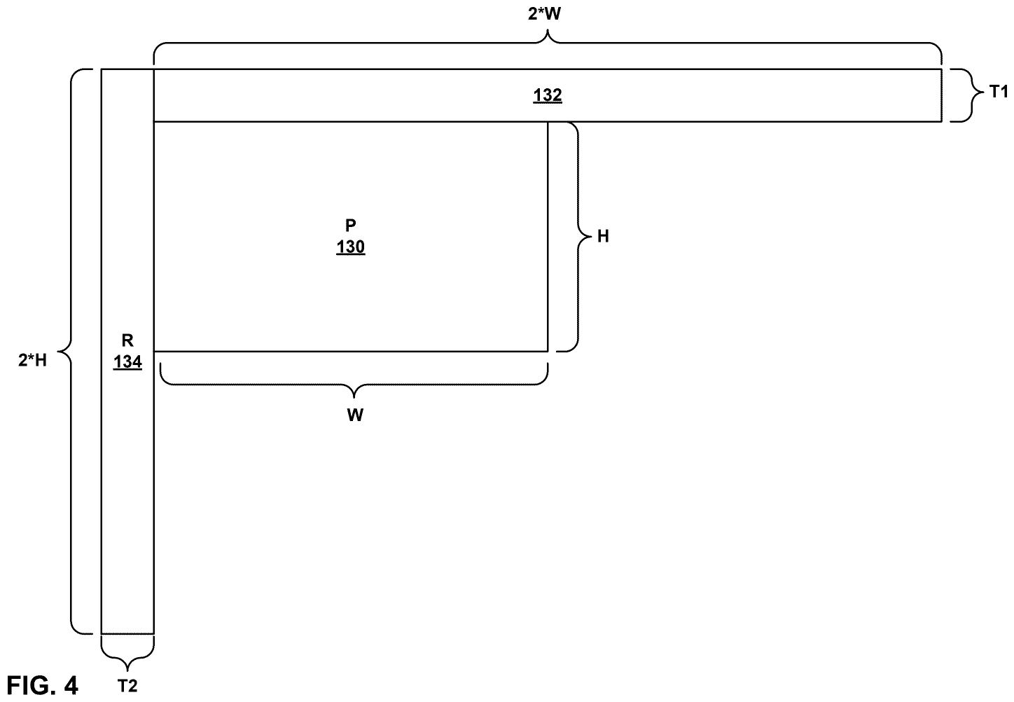

FIG. 4 is a block diagram illustrating an example causal template for a current block 130 of video data according to techniques of this disclosure. In particular, the causal template for current block 130 in this example includes rows 132 and columns 134. There are T1 rows in rows 132, and rows 132 have a width of 2*W, where current block 130 has a width of W. Likewise, there are T2 columns in columns 134, and columns 134 have a height of 2*H, where current block 130 has a height of H.

This disclosure describes techniques for performing sample position and block characteristic (e.g., block shape, intra-mode, and characteristics of the template) dependent prediction of samples. In general, for a given block, a causal template can be defined, which could be used as reference samples to perform the intra-prediction.

In some examples, a matrix of coefficients may be defined. Video encoder 200 or video decoder 300 may multiply this matrix by the reference template to produce the intra prediction block for the current block. One matrix may correspond to one predictor and there may be many matrices. Unlike MIP, for this technique, matrices are defined for conventional intra-prediction direction, and this matrix-based prediction may replace a conventional intra-prediction process for conventional intra-prediction modes (unlike MIP, which is added as a new mode, and does not replace a conventional intra-prediction direction).

Such matrices may be specific to an intra direction, block size, block shape, or the like. The reference template and the matrix itself may be subsampled by different subsampling factors to reduce memory storage and multiplication complexity. The subsampling factor may depend on intra direction, block size, block shape, or the like. Reference template size and shape may also depend on intra direction, block size, block shape, or the like.

To reduce memory storage, several intra directions, block size, block shapes, and so on may share the same matrix of coefficients. Similarly, some intra directions, block size, and/or block shapes may not use this matrix, based intra prediction; thus, storing the coefficients may not be required.

As shown in the FIG. 4, for current block 130 of dimensions W*H, an L shaped template (r), in one example, with dimensions of 2*W and 2*H as width and height, may be used. In some examples, instead of 2*W and 2*H for the template dimensions, any arbitrary dimension for the template can be chosen. In this example, rows 132 include T1 rows and columns 134 include T2 columns. Thus, the template includes a total number of reference pixels N equal to (T1*2*W+T2*2*H+T1*T2). This template may be used to predict current block 130, having area M=W×H. Video encoder 200 and video decoder 300 may form the prediction blocking using a filter/matrix F, e.g., according to the following formula:

P(x,y)=ΣₖF(x,y,k)*r(k)

In this example, P(x, y) represents the value of a predicted sample at position (x, y), F(x, y, k) represents a filter coefficient for the filter/matrix, and r(k) represents the k^{th} sample of the template including rows 132 and columns 134. In some examples, F(x,y,k) could be made dependent on the block shape and intra prediction mode. i.e., F(x,y,k)→F(W,H, mode,x,y,k).

In some examples, F(x,y,k) could be made dependent on the template characteristics, i.e., different filters could be applied depending on the degree of texture or smoothness of the template. For example, a high texture/high gradient containing template can use a different filter compared to a low gradient/smooth template.

In some other examples, in addition to the linear filtering, an offset term can also be added to the final prediction signal.

In general, the filtering process is not limited to linear filtering. Higher order filtering may also be applied. In some examples, the higher order filtering may be represented by the following formula:

P(x,y)=ΣₖΣₙF(x,y,k,n)*r(k)ⁿ

where n is an exponent factor, which may vary, for example, from 1 to some number N larger than 1.

In some examples, the filtering can also be applied to zero-mean signal, i.e., before the filtering process, the mean can be subtracted, and after the prediction, the mean can be added.

In some other examples, a flag may be used to enable/disable this filtering process for all blocks in a given block, slice, picture, or sequence levels.

In some examples, a CU/CTU level flag can be used for this mode. Alternatively, this technique can be implicit and only be used for certain block shapes/intra-modes. Moreover, if this technique is used, it can bypass the conventional intra-prediction process.

In some examples, this technique can be disabled for non-regular intra-prediction mode such as decoder-side intra mode derivation (DIMD), template-based intra mode derivation (TIMD), multiple reference lines (MRL), spatial geometric partition mode (SGPM), or the like.

In some other examples, for SGPM, predictor from both segments can use this technique instead of conventional intra-prediction, or alternatively one of the segments could use this technique (indication of which segment may be either implicit or explicit).

In some examples, when the reference samples for the causal template are partially available, padding can be used to generate the unavailable pixels. In one example, the padding process can be similar to padding of reference pixels used in VVC/ECM intra prediction.

The filter dimension is N×M, which could be large when N or M is large enough. Several techniques can be applied to reduce the memory consumption and computational complexity of the prediction process. These criteria can be implicit (without signaling) or explicit (signaling) such as:
This mode can only be applied to certain block sizes. For example, this mode can be disabled for certain or larger block sizes. For example, if the area is larger than a certain threshold, this technique can be disabled. Alternatively, if the maximum (or minimum) dimension of the block is larger than some threshold, this technique can be disabled.
In some examples, this technique can be applied to blocks having only certain aspect ratios. In some examples, this technique is not applied to blocks having narrow shapes.
For certain angular prediction modes, this technique can be disabled. The set of angular prediction modes (e.g., the number of modes) can be different for different block sizes. For example, for a block size with width and height both lower than 32, the mode-set: {0,1 and (2+2*k)(k={0,32})} is where this technique can be applied, and for other sizes of blocks, the mode-set: {0,1 and (2+4*k)(k={0,16})} is where this technique can be applied. This is to adjust the tradeoff between memory/coding complexity and performance.
A number of reference lines used for doing the prediction can be adaptive based on block size. For example, for smaller blocks, e.g., width and height both less than 16 (4×4/4×8/8×4/8×8), 4 reference line can be used. For middle sized blocks, where both height and width do not exceed 16 (4×16/8×16/16×16/16×8/16×16), two reference lines may be used. And for other (larger) blocks (16×32/32×16/32×32), 1 reference line can be used. This is to adjust the tradeoff between memory/coding complexity and performance.
For certain block sizes, the reference samples can be down-sampled (in order to reduce the dimension) before being provided as an input to the filter (input pre-processing).
For certain block sizes, the prediction P(x,y) generated from the filter can be of reduced dimension and subsequently up-sampled to meet the final prediction signal dimensions. For example, for a block size of 32×32, matrix-based prediction may generate values for 16×16 positions (quarter of the actual block pixels) and other pixels of the block can be generated using bilinear interpolation. Moreover, the 16×16 positions can be generated for positions for which both x and y are odd, i.e., x % 2==1 and y % 2==1. As another example, for a block size 32×16, only odd columns (x % 2==1) may be generated, and bilinear interpolation may be performed to generate values for other pixels. Similarly, for a block size 16×32, only odd rows (y % 2==1) may be generated, and bilinear interpolation may be performed to generate other pixels. For the pixels near boundary positions, a nearest reference line can be used to perform interpolation (like MIP). Moreover, a set of interpolation filters can be defined per-mode to improve the quality of interpolation.
The sampling grid may be non-uniform. The sampling pattern may depend on the position of the sample inside the block. For example, a dense sampling pattern may be used when the pixel position is near to the boundary, and coarse sampling patterns can be used when the position is far from the boundary. So, position/region dependent sampling patterns can be used.
For certain-prediction modes, a reduced template size (instead of 2*W and 2*H) can be used. For example, from mode 19 to mode 49, only template W and H can be used, respectively, for width and height dimension (as for those modes, top-right and/or bottom left pixels may not be that useful for the prediction).
The filters may have a symmetry feature, i.e., filters for predicting a block W×H with intra-mode m can be a transposed version of the filter for predicting a block H×W with mode (67−m). (This is considering a total of 67 modes. However, if there are S modes with angles distributed similarly to VVC intra modes, W×H blocks with mode m would correspond to H×W mode (S−m)). Additionally, for some modes (e.g., modes 0, 1, and 34) symmetry may not be permitted, and for the rest modes, symmetry may be permitted.
For certain modes, a reduced template pattern may be used for prediction, and this pattern might be different for different intra modes/block shapes/template characteristics.

The matrix-based prediction method described above may be used in a combination with other modes. There may be several distinct cases: the single mode case and mode blending or fusion, where multiple prediction modes are blended together with weights.

The matrix-based prediction modes may be considered to generate more accurate predictors due to larger template sizes and more tailored towards a certain block shape and intra mode. In such cases, if the described mode is used, then the blending is not applied. For example, a blending of the intra predictions derived from the closest reference line and other reference line may be performed. So, if the described mode is used then such blending is not performed, because such blending may reduce the accuracy of the prediction.

In some examples, any blending or fusion or a combination is not applied with the described method when an intra direction is explicitly signaled, to maintain accuracy of the intra prediction.

However, for some classes of modes, intra mode is not explicitly signaled and is derived. Examples of such modes are DIMD, TIMD, and the like. In such modes, the intra mode is derived using neighbor reconstructed samples by video encoder 200 and video decoder 300. Multiple intra modes may be derived and blended together. In such cases, since the intra direction is not signaled, it may not be as accurate when it is explicitly chosen by video encoder 200 and signaled, and blending may be performed to smooth out the potential discrepancy. In such cases, the described matrix-based prediction method may be used for those methods and with blending.

In some examples, it may be expressed as follows: the described matrix-based prediction method is applied to modes which are based on derivation of the intra direction, optionally without explicit intra direction signaling, and blending with multiple intra directions is performed.

There are generally two types of intra modes: directional intra prediction, such as horizontal, vertical, diagonal and other angles, and non-directional intra mode, such as planar and DC modes. The described matrix-based intra prediction may be used for directional-only modes. Alternatively, the described matrix-based intra prediction method may be used for directional-only intra modes if blending, fusion, or any combination of modes are utilized to form a final intra prediction.

In some examples, the described matrix-based prediction method is applied in DIMD mode, additionally when blending with multiple derived modes is used.

In some examples, the combination with other modes, such as DIMD, can be restricted up to certain block sizes. For example, this matrix-based intra prediction can be combined with DIMD when the both the block width and height are smaller than a threshold (e.g. threshold=16).

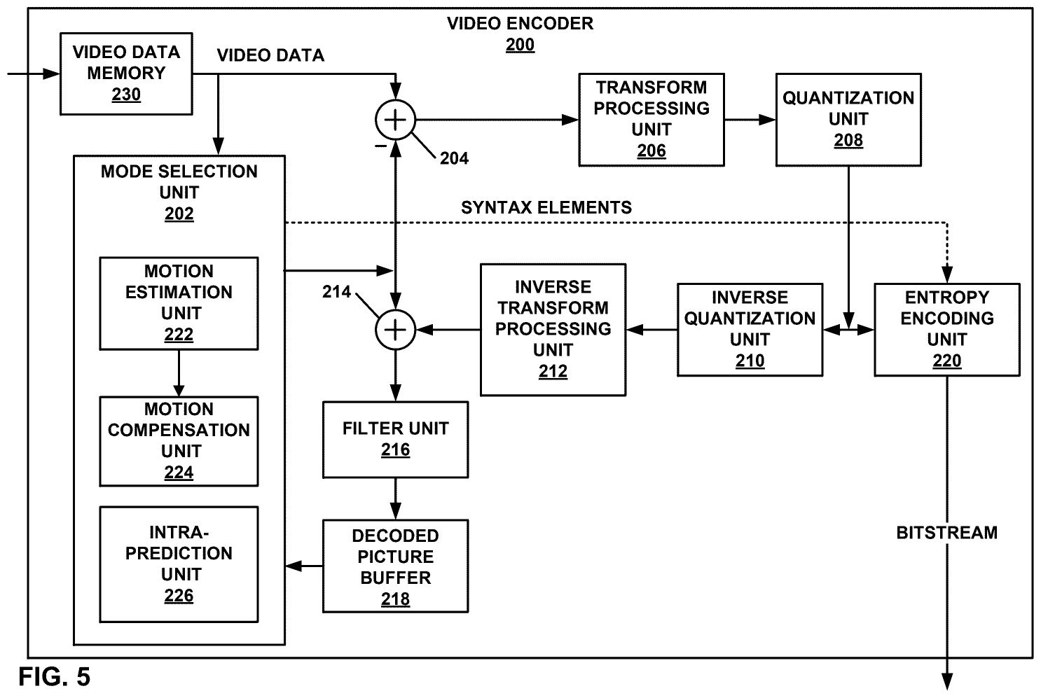

FIG. 5 is a block diagram illustrating an example video encoder 200 that may perform the techniques of this disclosure. FIG. 5 is provided for purposes of explanation and should not be considered limiting of the techniques as broadly exemplified and described in this disclosure. For purposes of explanation, this disclosure describes video encoder 200 according to the techniques of VVC (ITU-T H.266, under development) and HEVC (ITU-T H.265). However, the techniques of this disclosure may be performed by video encoding devices that are configured to other video coding standards and video coding formats, such as AV1 and successors to the AV1 video coding format.

In the example of FIG. 5, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 5 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure, superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block. Intra-prediction unit 226 may be configured to perform any of the various techniques of this disclosure to perform sample position and block characteristic-based intra prediction.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 22 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

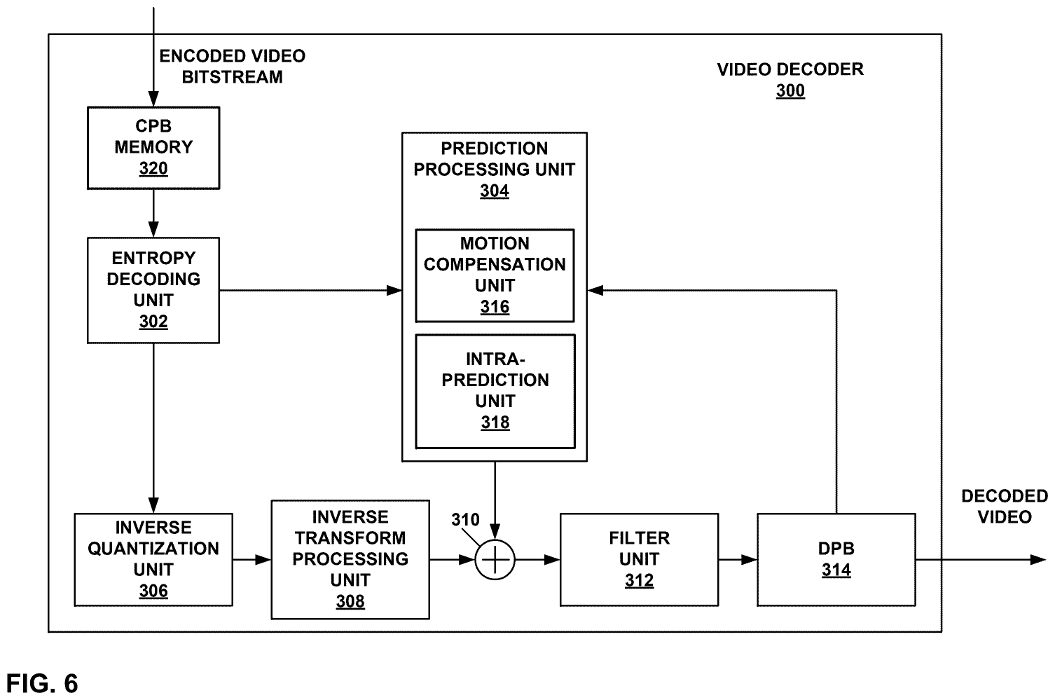

FIG. 6 is a block diagram illustrating an example video decoder 300 that may perform the techniques of this disclosure. FIG. 6 is provided for purposes of explanation and is not limiting on the techniques as broadly exemplified and described in this disclosure. For purposes of explanation, this disclosure describes video decoder 300 according to the techniques of VVC (ITU-T H.266, under development) and HEVC (ITU-T H.265). However, the techniques of this disclosure may be performed by video coding devices that are configured to other video coding standards.

In the example of FIG. 6, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, intra block copy (IBC), and/or color palette mode, as described above. Intra-prediction unit 318 may be configured to perform any of the various techniques of this disclosure to perform sample position and block characteristic-based intra prediction.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 6 are illustrated to assist with understanding the operations performed by video decoder 300. The units may be implemented as fixed-function circuits, programmable circuits, or a combination thereof. Similar to FIG. 5, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 5).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 5). Intra-prediction unit 318 may retrieve data of neighboring samples to the current block from DPB 314, e.g., from a causal template.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

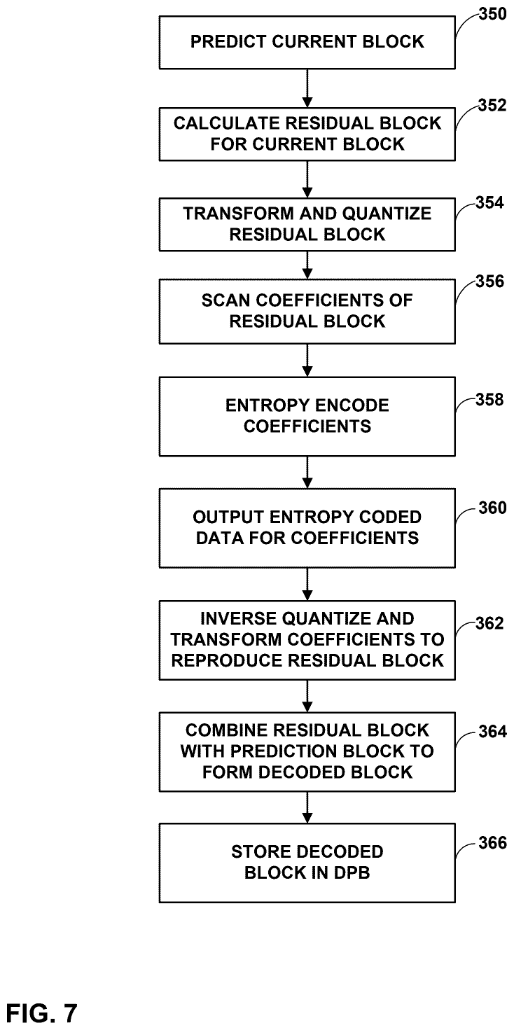

FIG. 7 is a flowchart illustrating an example method for encoding a current block in accordance with the techniques of this disclosure. The current block may comprise a current CU. Although described with respect to video encoder 200 (FIGS. 1 and 5), it should be understood that other devices may be configured to perform a method similar to that of FIG. 7.

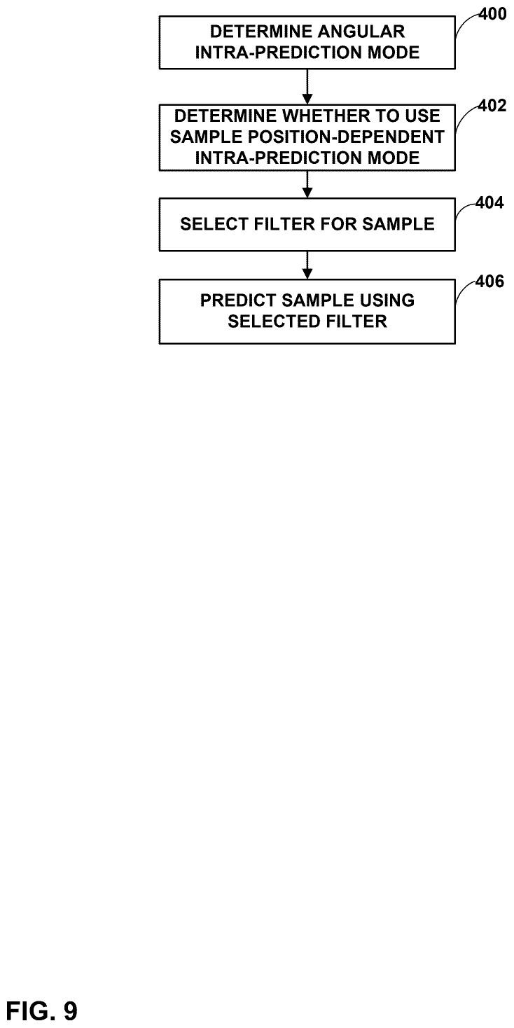

In this example, video encoder 200 initially predicts the current block (350). For example, video encoder 200 may form a prediction block for the current block, e.g., using a sample position-dependent intra-prediction mode per the techniques of this disclosure, e.g., as discussed in greater detail below with respect to FIG. 9 below. Video encoder 200 may then calculate a residual block for the current block (352). To calculate the residual block, video encoder 200 may calculate a difference between the original, uncoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

Video encoder 200 may also decode the current block after encoding the current block, to use the decoded version of the current block as reference data for subsequently coded data (e.g., in inter- or intra-prediction modes). Thus, video encoder 200 may inverse quantize and inverse transform the coefficients to reproduce the residual block (362). Video encoder 200 may combine the residual block with the prediction block to form a decoded block (364). Video encoder 200 may then store the decoded block in DPB 218 (366).

In this manner, the method of FIG. 7 represents an example of a method of encoding video data, including: generating a prediction block for a current block of the video data using a sample position-dependent intra-prediction mode, including, for one or more samples of the prediction block: selecting a filter for the sample according to a shape of the current block and a position of the sample; and predicting the sample using the selected filter; forming a residual block for the current block of the video data as a sample-by-sample difference between the current block and the prediction block; and encoding the residual block and prediction information representative of the sample position-dependent intra-prediction mode for the current block.

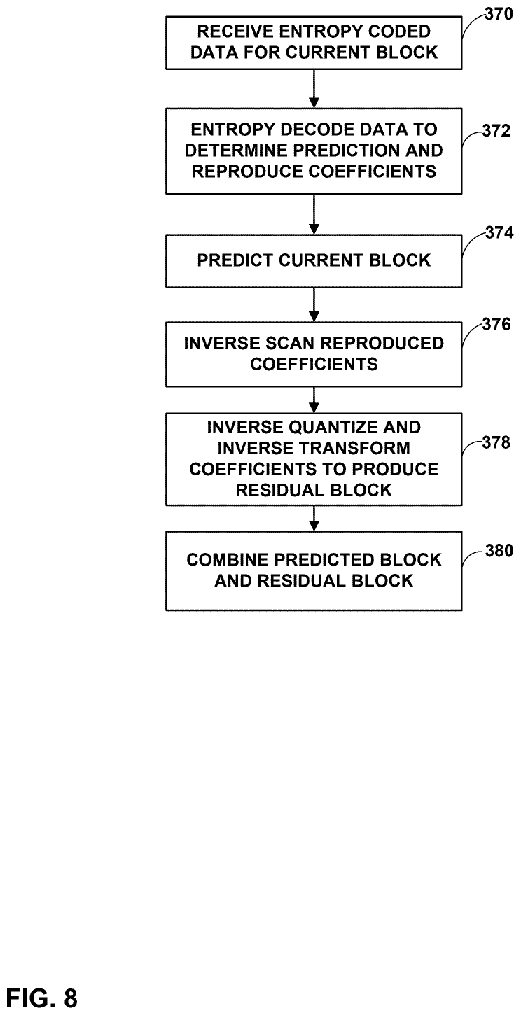

FIG. 8 is a flowchart illustrating an example method for decoding a current block of video data in accordance with the techniques of this disclosure. The current block may comprise a current CU. Although described with respect to video decoder 300 (FIGS. 1 and 6), it should be understood that other devices may be configured to perform a method similar to that of FIG. 8.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using a sample position-dependent intra-prediction mode per the techniques of this disclosure, as indicated by the prediction information for the current block and other characteristics of the current block, e.g., per the techniques of FIG. 9 below, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

In this manner, the method of FIG. 8 represents an example of a method of decoding video data, including: generating a prediction block for a current block of the video data using a sample position-dependent intra-prediction mode, including, for one or more samples of the prediction block: selecting a filter for the sample according to a shape of the current block and a position of the sample; and predicting the sample using the selected filter; decoding a residual block for the current block of the video data; and combining the prediction block with the residual block to decode the current block of the video data.

FIG. 9 is a flowchart illustrating an example method of predicting a block of video data according to techniques of this disclosure. The method of FIG. 9 includes predicting the block using a sample position-dependent intra-prediction mode per techniques of this disclosure. The method of FIG. 9 may be performed by video encoder 200, e.g., at step 350 of FIG. 7. Similarly, the method of FIG. 9 may be performed by video decoder 300, e.g., at step 374 of FIG. 8. For purposes of example and explanation, the method of FIG. 9 is explained with respect to video decoder 300.

Initially, video decoder 300 may determine an angular prediction mode (400) for a current block of video data. For example, video decoder 300 may receive an index value representative of the angular intra-prediction mode. Alternatively, video decoder 300 may perform a decoder-side angular intra-prediction mode derivation technique, such as DIMD, TIMD, MRL, SGPM.

Video decoder 300 may then determine whether to use the sample position-dependent intra-prediction mode techniques of this disclosure for the current block (402). This determination may be based on, for example, any or all of a size of the current block, an aspect ratio of the current block, the angular intra-prediction mode for the current block, or the like. In the example of FIG. 9, it is assumed that video decoder 300 determines to perform the sample position-dependent angular intra-prediction mode.

Thus, video decoder 300 may determine a set of samples of the current block for which to perform the sample position-dependent angular intra-prediction mode. The set of samples may be all samples of the current block or a subset of the samples of the current block. If the set is a subset of the samples of the current block, after predicting values for each of the samples of the set, resulting in an intermediate prediction block, video decoder 300 may interpolate the values of the set to upsample the intermediate prediction block, thereby forming the final prediction block for the current block.

For each sample of the set, video decoder 300 may select a filter for the sample (404). Thus, different filters may be selected for each sample of the set. Video decoder 300 may determine the filter based on any or all of a size of the current block, a shape of the current block, or a position of the sample in the current block.

Video decoder 300 may then predict the sample using the selected filter (406). For example, video decoder 300 may determine a causal neighborhood to the current block to which to apply the selected filter. The causal neighborhood may include one or more lines of reference samples neighboring the current block, and may be as wide or wider and/or as tall or taller than the current block, e.g., as shown in FIG. 4. Video decoder 300 may apply the filter to the causal neighborhood to calculate a value for the sample. Alternatively, in some examples, certain filters may be symmetrical to each other for angular intra-prediction modes that are opposite directions. For such angular intra-prediction modes, video decoder 300 may first transpose the selected filter, then apply the transposed filter to the causal neighborhood to calculate a value for the sample.

The following clauses represent various examples of the techniques of this disclosure:
Clause 1: A method of decoding video data, the method comprising: generating a prediction block for a current block of the video data using an intra-prediction mode according to a shape of the current block and characteristics of a causal template neighboring the current block; decoding a residual block for the current block of the video data; and combining the prediction block with the residual block to decode the current block of the video data.
Clause 2: The method of clause 1, wherein generating the prediction block comprises multiplying a matrix of coefficients by the causal template to produce the prediction block.
Clause 3: The method of clause 2, further comprising selecting the matrix of coefficients from a set of available matrices according to one or more of a direction of the intra-prediction, the shape of the current block, or a size of the current block.
Clause 4: The method of any of clauses 2 and 3, wherein multiplying the matrix of coefficients by the causal template comprises subsampling the matrix of coefficients using a first subsampling factor and subsampling the causal template using a second subsampling factor.
Clause 5: The method of clause 4, wherein at least one of the first subsampling factor or the second subsampling factor corresponds to one or more of the direction of the intra-prediction, the shape of the current block, or the size of the current block.
Clause 6: The method of any of clauses 2-5, wherein the matrix of coefficients corresponds to multiple directions of intra-prediction, block sizes, or block shapes.
Clause 7: The method of any of clauses 1-6, wherein the current block has a width of W and a height of H, and wherein the causal template includes at least one of one or more 2*W-width rows of samples above the current block or 2*H-height columns of samples to the left of the current block.
Clause 8: The method of any of clauses 1-7, wherein generating the prediction block includes applying a filter during generation of the prediction block.
Clause 9: The method of clause 8, wherein the filter comprises a linear filter.
Clause 10: The method of clause 8, wherein the filter comprises a filter having a higher order than linear.
Clause 11: The method of any of clauses 8-10, wherein applying the filter comprises: prior to applying the filter, subtracting a mean from an intermediate prediction block to form a zero-mean prediction block; applying the filter to the zero-mean prediction block to form a filtered prediction block; and adding the mean to the filtered prediction block to generate the prediction block.
Clause 12: The method of any of clause 8-11, further comprising coding a flag having a value indicating that the filter is to be applied.
Clause 13: The method of clause 12, wherein coding the flag comprises coding the flag in one or more of a header of the current block, a slice header for a slice including the current block, a picture parameter set (PPS), or a sequence parameter set (SPS).
Clause 14: The method of any of clauses 1-13, wherein the current block is to be predicted using spatial geometric partition mode (SGPM), and wherein the prediction block comprises a prediction block for a first segment of the current block.
Clause 15: The method of clause 14, further comprising generating a prediction block for a second segment of the current block using conventional intra-prediction.
Clause 16: The method of clause 14, further comprising generating a prediction block for a second segment of the current block using a second intra-prediction mode according to the shape of the current block and characteristics of the causal template neighboring the current block.
Clause 17: The method of any of clauses 1-16, further comprising adding padding samples to the causal template when one or more samples to form the causal template are not available.
Clause 18: The method of clause 1, wherein generating the prediction block comprises multiplying a matrix of coefficients by the causal template to produce the prediction block.
Clause 19: The method of clause 18, further comprising selecting the matrix of coefficients from a set of available matrices according to one or more of a direction of the intra-prediction, the shape of the current block, or a size of the current block.
Clause 20: The method of clause 18, wherein multiplying the matrix of coefficients by the causal template comprises subsampling the matrix of coefficients using a first subsampling factor and subsampling the causal template using a second subsampling factor.
Clause 21: The method of clause 20, wherein at least one of the first subsampling factor or the second subsampling factor corresponds to one or more of the direction of the intra-prediction, the shape of the current block, or the size of the current block.
Clause 22: The method of clause 18, wherein the matrix of coefficients corresponds to multiple directions of intra-prediction, block sizes, or block shapes.
Clause 23: The method of clause 1, wherein the current block has a width of W and a height of H, and wherein the causal template includes at least one of one or more 2*W-width rows of samples above the current block or 2*H-height columns of samples to the left of the current block.
Clause 24: The method of clause 1, wherein generating the prediction block includes applying a filter during generation of the prediction block.
Clause 25: The method of clause 24, wherein the filter comprises a linear filter.
Clause 26: The method of clause 24, wherein the filter comprises a filter having a higher order than linear.
Clause 27: The method of clause 24, wherein applying the filter comprises: prior to applying the filter, subtracting a mean from an intermediate prediction block to form a zero-mean prediction block; applying the filter to the zero-mean prediction block to form a filtered prediction block; and adding the mean to the filtered prediction block to generate the prediction block.
Clause 28: The method of clause 24, further comprising coding a flag having a value indicating that the filter is to be applied.
Clause 29: The method of clause 28, wherein coding the flag comprises coding the flag in one or more of a header of the current block, a slice header for a slice including the current block, a picture parameter set (PPS), or a sequence parameter set (SPS).
Clause 30: The method of clause 1, wherein the current block is to be predicted using spatial geometric partition mode (SGPM), and wherein the prediction block comprises a prediction block for a first segment of the current block.
Clause 31: The method of clause 30, further comprising generating a prediction block for a second segment of the current block using conventional intra-prediction.
Clause 32: The method of clause 30, further comprising generating a prediction block for a second segment of the current block using a second intra-prediction mode according to the shape of the current block and characteristics of the causal template neighboring the current block.
Clause 33: The method of clause 1, further comprising adding padding samples to the causal template when one or more samples to form the causal template are not available.
Clause 34: The method of any of clauses 1-33, further comprising encoding the current block prior to decoding the current block.
Clause 35: A device for decoding video data, the device comprising one or more means for performing the method of any of clauses 1-34.
Clause 36: The device of clause 35, further comprising a display configured to display the decoded video data.
Clause 37: The device of any of clauses 35 and 36, wherein the device comprises one or more of a camera, a computer, a mobile device, a broadcast receiver device, or a set-top box.
Clause 38: The device of any of clauses 35-37, further comprising a memory configured to store the video data.
Clause 39: A computer-readable storage medium having stored thereon instructions that, when executed, cause a processor of a device for decoding video data to perform the method of any of clauses 1-34.
Clause 40: A device for decoding video data, the device comprising: means for generating a prediction block for a current block of the video data using an intra-prediction mode according to a shape of the current block and characteristics of a causal template neighboring the current block; means for decoding a residual block for the current block of the video data; and means for combining the prediction block with the residual block to decode the current block of the video data.
Clause 41: A method of decoding video data, the method comprising: generating a prediction block for a current block of the video data using a sample position-dependent intra-prediction mode, including, for one or more samples of the prediction block: selecting a filter for the sample according to a shape of the current block and a position of the sample; and predicting the sample using the selected filter; decoding a residual block for the current block of the video data; and combining the prediction block with the residual block to decode the current block of the video data.
Clause 42: The method of clause 41, wherein the filter comprises a matrix of coefficients, and wherein predicting the sample comprises multiplying the matrix of coefficients by a causal template neighboring the current block.
Clause 43: The method of clause 42, further comprising selecting the matrix of coefficients from a set of available matrices according to one or more of a direction of the intra-prediction or a size of the current block.
Clause 44: The method of clause 42, wherein multiplying the matrix of coefficients by the causal template comprises subsampling the matrix of coefficients using a first subsampling factor and subsampling the causal template using a second subsampling factor to generate an intermediate prediction block.
Clause 45: The method of clause 44, wherein at least one of the first subsampling factor or the second subsampling factor corresponds to one or more of the direction of the intra-prediction, the shape of the current block, or the size of the current block.
Clause 46: The method of clause 41, further comprising determining to use the sample position intra-prediction mode based on a size of the current block being below a threshold.
Clause 47: The method of clause 46, wherein the size corresponds to one of an area of the current block, a width of the current block, or a height of the current block.
Clause 48: The method of clause 41, further comprising determining to use the sample position intra-prediction mode based on an aspect-ratio for the current block.
Clause 49: The method of clause 41, further comprising determining to use the sample position intra-prediction mode when: a width of the current block is less than 32, the height of the current block is less than 32, and a signaled angular intra prediction mode for the current block has an index value of one of 0, 1, or (2+2*k) where k is an integer value between 0 and 32; or the width of the current block is greater than or equal to 32 or the height of the current block is greater than or equal to 32, and the signed angular intra prediction mode for the current block has the index value of 0, 1, or (2+4*k) where k is an integer value between 0 and 16.
Clause 50: The method of clause 41, wherein predicting the sample using the selected filter comprises: determining a number of reference lines of neighboring samples to the current block to which to apply the selected filter according to a size of the current block; and applying the selected filter to the number of reference lines of neighboring samples.
Clause 51: The method of clause 41, wherein generating the prediction block comprises: predicting a subsampled set of samples using respective filters for the subsampled set of samples to form an intermediate prediction block; and upsampling the intermediate prediction block to form the prediction block.
Clause 52: The method of clause 41, wherein the current block has a width of W and a height of H, and wherein a causal template to which the filter is to be applied includes at least one of one or more 2*W-width rows of samples above the current block or 2*H-height columns of samples to the left of the current block.
Clause 53: The method of clause 41, wherein the current block has a width of W and a height of H, and when a signaled angular intra prediction mode for the current block has an index value between 19 and 49, a causal template to which the selected filter is to be applied includes a W-width rows of samples above the current block and an H-height columns of samples to the left of the current block.
Clause 54: The method of clause 41, further comprising transposing the selected filter to form a transposed filter, wherein predicting the sample using the selected filter comprises predicting the filter using the transposed filter.
Clause 55: The method of clause 41, wherein generating the prediction block comprises generating the prediction block using a decoder-derived intra prediction mode.
Clause 56: The method of clause 55, wherein the decoder-derived intra prediction mode comprises one of decoder-side intra mode derivation (DIMD), template-based intra mode derivation (TIMD), multiple reference lines (MRL), or spatial geometric partition mode (SGPM).
Clause 57: A device for decoding video data, the device comprising: a memory for storing video data; and a processing system implemented in circuitry and configured to: generating a prediction block for a current block of the video data using a sample position-dependent intra-prediction mode, including, for one or more samples of the prediction block: select a filter for the sample according to a shape of the current block and a position of the sample; and predict the sample using the selected filter; decode a residual block for the current block of the video data; and combine the prediction block with the residual block to decode the current block of the video data.
Clause 58: The device of clause 57, wherein the processing system is further configured to use the sample position intra-prediction mode based on a size of the current block being below a threshold.
Clause 59: The device of clause 57, wherein the processing system is further configured to use the sample position intra-prediction mode based on an aspect-ratio for the current block.
Clause 60: The device of clause 57, wherein the processing system is further configured to use the sample position intra-prediction mode when: a width of the current block is less than 32, the height of the current block is less than 32, and a signaled angular intra prediction mode for the current block has an index value of one of 0, 1, or (2+2*k) where k is an integer value between 0 and 32; or the width of the current block is greater than or equal to 32 or the height of the current block is greater than or equal to 32, and the signed angular intra prediction mode for the current block has the index value of 0, 1, or (2+4*k) where k is an integer value between 0 and 16.
Clause 61: The device of clause 57, wherein to predict the sample using the selected filter, the processing system is configured to: determine a number of reference lines of neighboring samples to the current block to which to apply the selected filter according to a size of the current block; and apply the selected filter to the number of reference lines of neighboring samples.
Clause 62: The device of clause 57, wherein to generate the prediction block, the processing system is configured to: predict a subsampled set of samples using respective filters for the subsampled set of samples to form an intermediate prediction block; and upsample the intermediate prediction block to form the prediction block.
Clause 63: The device of clause 57, wherein the current block has a width of W and a height of H, and wherein a causal template to which the filter is to be applied includes at least one of one or more 2*W-width rows of samples above the current block or 2*H-height columns of samples to the left of the current block.
Clause 64: The device of clause 57, wherein the current block has a width of W and a height of H, and when a signaled angular intra prediction mode for the current block has an index value between 19 and 49, a causal template to which the selected filter is to be applied includes a W-width rows of samples above the current block and an H-height columns of samples to the left of the current block.
Clause 65: The device of clause 57, wherein the processing system is further configured to transpose the selected filter to form a transposed filter, wherein to predict the sample using the selected filter, the processing system is configured to predict the filter using the transposed filter.
Clause 66: The device of clause 57, wherein to generate the prediction block, the processing system is further configured to generate the prediction block using a decoder-derived intra prediction mode, the decoder-derived intra prediction mode comprising one of decoder-side intra mode derivation (DIMD), template-based intra mode derivation (TIMD), multiple reference lines (MRL), or spatial geometric partition mode (SGPM).
Clause 67: The device of clause 57, further comprising a display configured to display the decoded video data.
Clause 68: The device of clause 57, wherein the device comprises one or more of a camera, a computer, a mobile device, a broadcast receiver device, or a set-top box.
Clause 69: A method of encoding video data, the method comprising: generating a prediction block for a current block of the video data using a sample position-dependent intra-prediction mode, including, for one or more samples of the prediction block: selecting a filter for the sample according to a shape of the current block and a position of the sample; and predicting the sample using the selected filter; forming a residual block for the current block of the video data as a sample-by-sample difference between the current block and the prediction block; and encoding the residual block and prediction information representative of the sample position-dependent intra-prediction mode for the current block.
Clause 70: A device for encoding video data, the device comprising: a memory for storing video data; and a processing system implemented in circuitry and configured to: generate a prediction block for a current block of the video data using a sample position-dependent intra-prediction mode, including, for one or more samples of the prediction block: select a filter for the sample according to a shape of the current block and a position of the sample; and predict the sample using the selected filter; form a residual block for the current block of the video data as a sample-by-sample difference between the current block and the prediction block; and encode the residual block and prediction information representative of the sample position-dependent intra-prediction mode for the current block.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
generating a prediction block for a current block of the video data using a sample position-dependent intra-prediction mode, including, for one or more samples of the prediction block:
selecting a filter for the sample according to a shape of the current block and a position of the sample; and
predicting the sample using the selected filter;
decoding a residual block for the current block of the video data; and
combining the prediction block with the residual block to decode the current block of the video data.

2. The method of claim 1, wherein the filter comprises a matrix of coefficients, and wherein predicting the sample comprises multiplying the matrix of coefficients by a causal template of samples neighboring the current block.

3. The method of claim 2, further comprising selecting the matrix of coefficients from a set of available matrices according to one or more of a direction of the intra-prediction or a size of the current block.

4. The method of claim 2, wherein multiplying the matrix of coefficients by the causal template comprises subsampling the matrix of coefficients using a first subsampling factor and subsampling the causal template using a second subsampling factor to generate an intermediate prediction block.

5. The method of claim 4, wherein at least one of the first subsampling factor or the second subsampling factor corresponds to one or more of a direction of the intra-prediction, the shape of the current block, or a size of the current block.

6. The method of claim 1, further comprising determining to use the sample position-dependent intra-prediction mode based on a size of the current block being below a threshold.

7. The method of claim 6, wherein the size corresponds to one of an area of the current block, a width of the current block, or a height of the current block.

8. The method of claim 1, further comprising determining to use the sample position-dependent intra-prediction mode based on an aspect-ratio for the current block.

9. The method of claim 1, further comprising determining to use the sample position-dependent intra-prediction mode when:
a width of the current block is less than 32, a height of the current block is less than 32, and a signaled angular intra prediction mode for the current block has an index value of one of 0, 1, or (2+2*k) where k is an integer value between 0 and 32; or
the width of the current block is greater than or equal to 32 or the height of the current block is greater than or equal to 32, and the signed angular intra prediction mode for the current block has the index value of 0, 1, or (2+4*k) where k is an integer value between 0 and 16.

10. The method of claim 1, wherein predicting the sample using the selected filter comprises:
determining a number of reference lines of neighboring samples to the current block to which to apply the selected filter according to a size of the current block; and
applying the selected filter to the number of reference lines of neighboring samples.

11. The method of claim 1, wherein generating the prediction block comprises:
predicting a subsampled set of samples using respective filters for the subsampled set of samples to form an intermediate prediction block; and
upsampling the intermediate prediction block to form the prediction block.

12. The method of claim 1, wherein the current block has a width of W and a height of H, and wherein a causal template to which the filter is to be applied includes at least one of one or more 2*W-width rows of samples above the current block or 2*H-height columns of samples to the left of the current block.

13. The method of claim 1, wherein the current block has a width of W and a height of H, and when a signaled angular intra prediction mode for the current block has an index value between 19 and 49, a causal template to which the selected filter is to be applied includes a W-width rows of samples above the current block and an H-height columns of samples to the left of the current block.

14. The method of claim 1, further comprising transposing the selected filter to form a transposed filter, wherein predicting the sample using the selected filter comprises predicting the filter using the transposed filter.

15. The method of claim 1, wherein generating the prediction block comprises generating the prediction block using a decoder-derived intra prediction mode.

16. The method of claim 15, wherein the decoder-derived intra prediction mode comprises one of decoder-side intra mode derivation (DIMD), template-based intra mode derivation (TIMD), multiple reference lines (MRL), or spatial geometric partition mode (SGPM).

17. A device for decoding video data, the device comprising:
a memory for storing video data; and
a processing system implemented in circuitry and configured to:
generating a prediction block for a current block of the video data using a sample position-dependent intra-prediction mode, including, for one or more samples of the prediction block:
select a filter for the sample according to a shape of the current block and a position of the sample; and
predict the sample using the selected filter;
decode a residual block for the current block of the video data; and
combine the prediction block with the residual block to decode the current block of the video data.

18. The device of claim 17, wherein the processing system is further configured to use the sample position-dependent intra-prediction mode based on a size of the current block being below a threshold.

19. The device of claim 17, wherein the processing system is further configured to use the sample position-dependent intra-prediction mode based on an aspect-ratio for the current block.

20. The device of claim 17, wherein the processing system is further configured to use the sample position-dependent intra-prediction mode when:
a width of the current block is less than 32, a height of the current block is less than 32, and a signaled angular intra prediction mode for the current block has an index value of one of 0, 1, or (2+2*k) where k is an integer value between 0 and 32; or
the width of the current block is greater than or equal to 32 or the height of the current block is greater than or equal to 32, and the signed angular intra prediction mode for the current block has the index value of 0, 1, or (2+4*k) where k is an integer value between 0 and 16.

21. The device of claim 17, wherein to predict the sample using the selected filter, the processing system is configured to:
determine a number of reference lines of neighboring samples to the current block to which to apply the selected filter according to a size of the current block; and
apply the selected filter to the number of reference lines of neighboring samples.

22. The device of claim 17, wherein to generate the prediction block, the processing system is configured to:
predict a subsampled set of samples using respective filters for the subsampled set of samples to form an intermediate prediction block; and
upsample the intermediate prediction block to form the prediction block.

23. The device of claim 17, wherein the current block has a width of W and a height of H, and wherein a causal template to which the filter is to be applied includes at least one of one or more 2*W-width rows of samples above the current block or 2*H-height columns of samples to the left of the current block.

24. The device of claim 17, wherein the current block has a width of W and a height of H, and when a signaled angular intra prediction mode for the current block has an index value between 19 and 49, a causal template to which the selected filter is to be applied includes a W-width rows of samples above the current block and an H-height columns of samples to the left of the current block.

25. The device of claim 17, wherein the processing system is further configured to transpose the selected filter to form a transposed filter, wherein to predict the sample using the selected filter, the processing system is configured to predict the filter using the transposed filter.

26. The device of claim 17, wherein to generate the prediction block, the processing system is further configured to generate the prediction block using a decoder-derived intra prediction mode, the decoder-derived intra prediction mode comprising one of decoder-side intra mode derivation (DIMD), template-based intra mode derivation (TIMD), multiple reference lines (MRL), or spatial geometric partition mode (SGPM).

27. The device of claim 17, further comprising a display configured to display the decoded video data.

28. The device of claim 17, wherein the device comprises one or more of a camera, a computer, a mobile device, a broadcast receiver device, or a set-top box.

29. A method of encoding video data, the method comprising:
generating a prediction block for a current block of the video data using a sample position-dependent intra-prediction mode, including, for one or more samples of the prediction block:
selecting a filter for the sample according to a shape of the current block and a position of the sample; and
predicting the sample using the selected filter;
forming a residual block for the current block of the video data as a sample-by-sample difference between the current block and the prediction block; and
encoding the residual block and prediction information representative of the sample position-dependent intra-prediction mode for the current block.

30. A device for encoding video data, the device comprising:
a memory for storing video data; and
a processing system implemented in circuitry and configured to:
generate a prediction block for a current block of the video data using a sample position-dependent intra-prediction mode, including, for one or more samples of the prediction block:
select a filter for the sample according to a shape of the current block and a position of the sample; and
predict the sample using the selected filter;
form a residual block for the current block of the video data as a sample-by-sample difference between the current block and the prediction block; and
encode the residual block and prediction information representative of the sample position-dependent intra-prediction mode for the current block.
